(19) United States
(12) Patent Application Publication
(10) Pub. No.: US 2010/0013238 A1
(43) Pub. Date: Jan. 21, 2010

(54) VERTICAL AXIS WIND TURBINE AND GENERATOR

(75) Inventors: Darryl Jessie, Saskatoon (CA); Dave A. Cote, Vanscoy (CA)

Correspondence Address: LAW OFFICES OF ALBERT WAI-KIT CHAN, PLLC, 141-07 20TH AVENUE, WORLD PLAZA, SUITE 604, WHITESTONE, NY, 11357, US

(73) Assignee: Darryl Jessie, Saskatoon, Saskatchewan (CA)

(21) Appl. No.: 12/514,846

(22) PCT Filed: Nov. 14, 2007
(86) PCT No.: PCT/CA07/02031

§ 371 Date: Oct. 1, 2009

(30) Foreign Application Priority Data
Nov. 14, 2006 (CA) 2567923

(51) Int. Cl. F03D 3/06; F03D 3/02; F03D 11/02; F03D 11/04

(52) U.S. Cl. 290/55

(57) ABSTRACT

A wind turbine and generator apparatus for mounting on a substantially vertical fixed cylindrical object includes a stationary generator member encircling the cylindrical object and fixed to the cylindrical object. A rotating generator member encloses the stationary generator member, and is rotatably supported by the stationary generator member. A plurality of blades is mounted to the rotating generator member such that a wind contacting the blades is operative to rotate the rotating generator member about the stationary generator member to generate electrical energy.

This invention is in the field of wind energy and in particular a vertical axis wind turbine and generator for mounting on a substantially vertical cylindrical object.

### BACKGROUND

Wind turbines generally are configured either as a horizontal axis wind turbine (HAWT) where the rotational axis is substantially aligned with the wind direction, or as a vertical axis wind turbine (VAWT) where the rotational axis is substantially vertical and perpendicular to the wind direction. The HAWT typically must be mounted so as to pivot about a vertical axis to align itself with the wind direction, while a VAWT generally can be fixed, since it will be rotated by the wind regardless of the wind direction. Thus the VAWT is somewhat less complex, and provides improved operation where winds are turbulent, such as in urban areas where buildings affect wind flow.

Wind turbines are typically mounted on towers that position the turbines a significant distance above the ground where wind speeds are generally higher and more stable. The tower adds significantly to the cost of the installation.

### SUMMARY OF THE INVENTION

It is an object of the present invention to provide a vertical axis wind turbine and generator that overcomes problems in the prior art.

In a first embodiment the present invention provides a wind turbine and generator apparatus for mounting on a substantially vertical fixed cylindrical object. The apparatus comprises a stationary generator member adapted to be fixed to the cylindrical object such that the stationary generator member encircles the cylindrical object. A rotating generator member substantially encloses the stationary generator member, and is rotatably supported by the stationary generator member. A plurality of blades is mounted to the rotating generator member such that a wind contacting the blades is operative to rotate the rotating generator member about the stationary generator member to generate electrical energy.

In a second embodiment the present invention provides an apparatus for generating electricity from wind. The apparatus comprises a substantially vertical electrical utility pole supporting at least one electrical conductor. A stationary generator member encircles the utility pole and is fixed to the utility pole. A rotating generator member substantially encloses the stationary generator member, and is rotatably supported by the stationary generator member. A plurality of blades is mounted to the rotating generator member such that a wind contacting the blades is operative to rotate the rotating generator member about the stationary generator member to generate electrical energy, and a circuit is connected to the stationary generator member and the at least one electrical conductor and is configured to transform the electrical energy generated as required and to conduct the transformed electrical energy into the at least one electrical conductor.

The apparatus of the invention provides a vertical axis wind turbine and generator that is readily installed on existing cylindrical objects like chimneys, pipes, poles, etc., and that can take advantage of wind speed acceleration around a fixed cylindrical object.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of an embodiment of the apparatus of the present invention mounted on an electrical utility pole;

FIG. 2 is a perspective view of the un-assembled stationary generator components and rotating generator components that form the generator of the apparatus of FIG. 1;

FIG. 3 is a perspective view of the stationary generator components of FIG. 2 in an assembled state forming the stationary generator member of the apparatus of FIG. 1;

FIG. 4 is a perspective view of the assembled rotating generator components enclosing the stationary generator member of FIG. 2;

FIG. 5 is a perspective view of an alternate embodiment of an apparatus of the present invention mounted on a fixed cylindrical object such as a chimney, pipe, pole, or the like;

FIG. 6 is a schematic top view of the blades of the embodiment of FIG. 1 or FIG. 25;

FIG. 7 is a schematic diagram of air flow where a wind meets a fixed cylindrical object;

FIG. 8 is a graph of the wind speed of wind meeting a cylindrical object as in FIG. 7;

FIG. 9A is a schematic sectional view of a streamlined body;

FIG. 9B is a schematic sectional view of the streamlined body of FIG. 9A hollowed out to form the blade in the embodiment of FIG. 1 or FIG. 5;

FIG. 10 is a schematic illustration of the Magnus effect where wind meets a rotating cylindrical object;

FIG. 11 is a perspective view of an alternate embodiment of an apparatus of the present invention mounted;

FIG. 12 is a schematic top view of the embodiment of FIG. 11.

### DETAILED DESCRIPTION OF THE ILLUSTRATED EMBODIMENTS

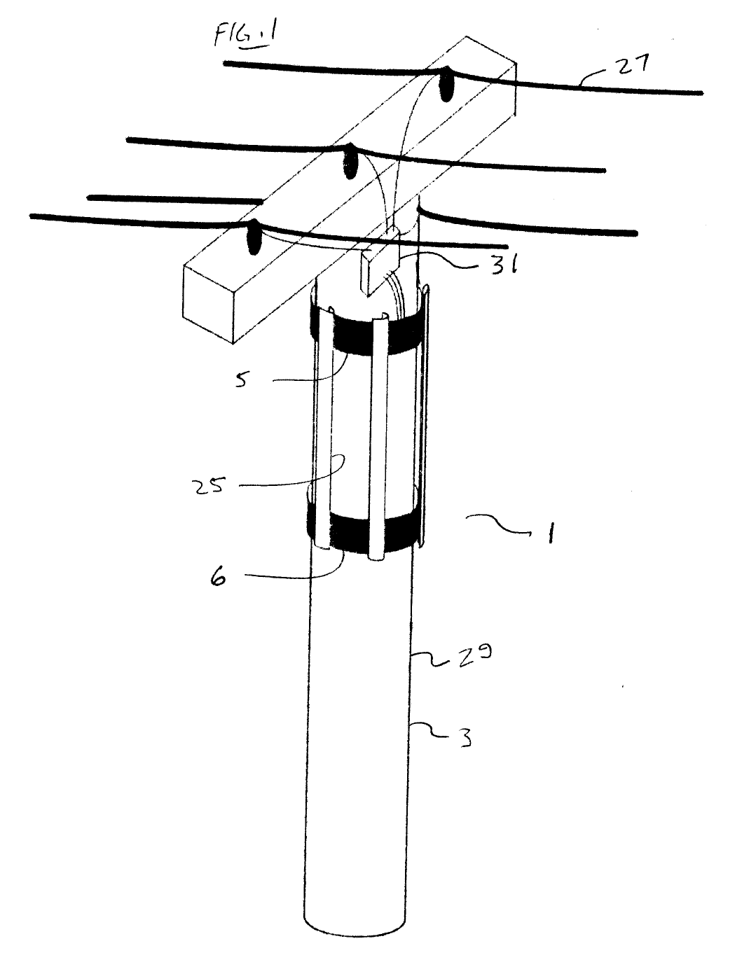

FIG. 1 illustrates a schematic view of an embodiment of a wind turbine and generator apparatus 1 of the present invention, mounted on a substantially vertical fixed cylindrical object 3, illustrated as an electrical utility pole, but which could also be a chimney, pipe, pole, or the like. The illustrated apparatus includes a generator 5, and a bearing 6.

The generator 5 comprises, as is well known in the art, a stationary generator member and a rotating generator member that encloses the stationary member, and the members are configured such that the as the rotating generator member rotates about the stationary generator member, an electrical current is generated. In the simplest embodiment the stationary member of the generator defines a central aperture sized to accommodate the cylindrical object 3, and the stationary member is installed on the cylindrical object 3 by inserting an end of the cylindrical object 3 through the aperture and moving the stationary generator member along the cylindrical object 3 to a desired location, and fixing it in place. The rotating generator member encloses the stationary generator member and is rotatably supported by the stationary generator member. The rotating generator member can similarly slide down the cylindrical object 3 to the stationary member after it is installed, or generator can be installed first and then slide down the cylindrical object to the desired location where suitable attachment flanges or the like on the stationary generator member can be fixed to the cylindrical object 3.

Similarly the bearing 6 comprises a stationary bearing member fixed to the cylindrical object 3 above or below the generator 5 and a rotating bearing member rotatably supported on the stationary bearing member. The blades 25 of the apparatus 1 are attached to the rotating generator and bearing members.

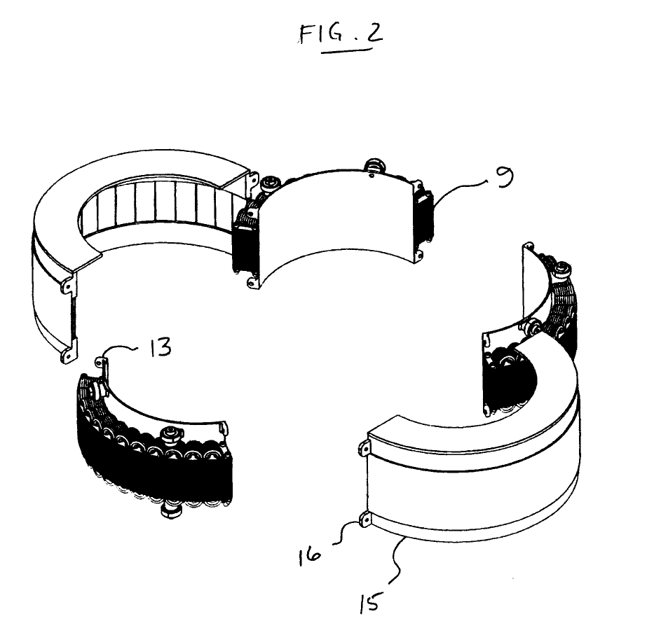

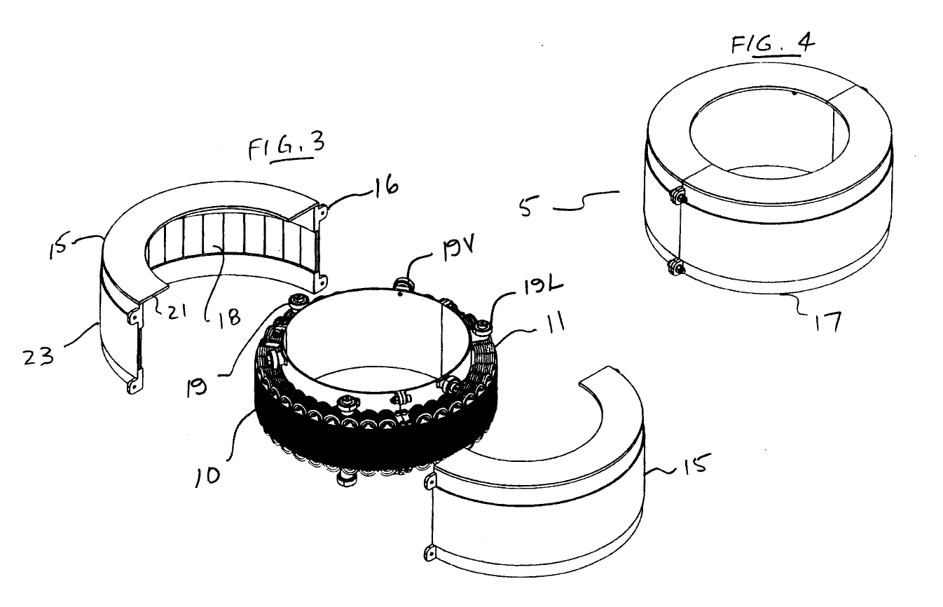

FIGS. 2-4 illustrate a convenient construction for the generator 5 that allows the generator to be attached to a cylindrical object without accessing the end of the object. The generator 5 comprises a plurality of stationary generator components 9 that are adapted to be assembled around the cylindrical object 3 to form a stationary generator member 11, as illustrated in FIG. 3, encircling the cylindrical object 3 and fixed to the cylindrical object 3 by bolts or like fasteners. The illustrated embodiment comprises three stationary generator components 9, each forming one third of the stationary generator member 11. The components 9 are placed around the cylindrical object 3 and then connected by bolts through flanges 13. Thus it is not required to have access to the end of the cylindrical object to slide the stationary generator member 11 over down the cylindrical object 3 to the desired location, but instead the stationary generator member 11 can be assembled easily around the cylindrical object 3 at the desired location.

Once the stationary generator member 1 is attached to the cylindrical object 3, a plurality of rotating generator components 15 are assembled around the stationary generator member 11 to form a rotating generator member 17 substantially enclosing the stationary generator member 11, and rotatably supported by the stationary generator member 11. In the illustrated embodiment there are two rotating generator components 15, each forming one half of the rotating generator member 17. The components 15 are connected around the stationary generator member 11 after same has been installed on the cylindrical object 3 by bolts through flanges 16. The stationary generator member 11 and rotating generator member 17 provide a conveniently installed form for the generator 5 shown schematically in FIG. 1.

In the illustrated generator 5 the stationary generator components 9 comprise wire windings 10, and the magnets 18 are mounted on the inner surface of the rotating generator components 15. The magnets 18 moving over the windings 10 create a current in the wires. A circuit 31 is connected to the stationary generator member 11 and the electrical conductors 27 on the utility pole 29. The circuit is configured to transform the electrical energy generated as required and then to conduct the transformed electrical energy into the electrical conductors 27. A passive circuit, such as a transformer, or an active circuit such as a converter/inverter could be utilized for example. Where a synchronous generator was utilized, the circuit 31 could simply conduct the output to the electrical conductors 27. Where the cylindrical object 3 is not a utility pole, wires will be connected as required to conduct the electrical energy to a desired location. Provision can be made to disconnect the circuit 31 remotely when it is desired to stop the flow of electrical energy from the generator 5.

In the illustrated embodiment, each stationary generator component 9 generates one phase of a three phase electrical output. Each stationary generator component 9 is then conveniently connected to the circuit 31 and then to each of the three conductors 27 of the three phase electrical power line illustrated. Other configurations of the generator 5 are contemplated as well. For example, an axial generator with parallel stacked plates provided with winding and magnets could also be used.

Rollers 19 are rotatably mounted on the stationary generator member 11 and are configured such that the rotating generator member 17 is supported on the rollers 19 for rotation about the stationary generator member 11. Vertical support rollers 19V are rotatably mounted about axes oriented substantially radially with respect to the stationary generator member 11. A top portion of the rotating generator member 17, the lower surface of the top flange 21 of the rotating generator member 17, rests on the vertical support rollers 19V and is thus supported vertically for rotation around the stationary generator member 11 and the cylindrical object 3. Lateral support rollers 19L are rotatably mounted about axes oriented substantially vertically with respect to the stationary generator member 11 and inner surfaces of the side walls 23 of the rotating generator member 17 contact the lateral support rollers 19L, and bear against the lateral support rollers 19V when subjected to wind forces.

Blades 25 are mounted to the rotating generator member 17 such that a wind contacting the blades 25 is operative to rotate the rotating generator member 17 about the stationary generator member 11 to generate electrical energy.

In the illustrated embodiment of FIG. 1 the blades 25 are configured in an upright orientation. In the alternate embodiment of the apparatus 101 illustrated in FIG. 5, the blades 125 are attached to the rotating generator member 117 of only generator 105 that is attached around a cylindrical object 103 that could be a pipe, chimney, or the like. The blades 125 extend upward and downward from the rotating generator member 117. Depending on the scale of the apparatus 101, the generator 105 could support blades 125 with a moderate length.

The apparatus 1 illustrated in FIG. 1 provides an embodiment where it is desired to have longer blades, and an increased power output. The blades 25 are attached at upper and lower portions thereof to generator 5 at one end and the bearing 6 at the opposite end, and are thus better supported for rotation about the cylindrical object 3. In the illustrated embodiment the generator 5 is located above the bearing 6, conveniently near the electrical conductor 27, however it is contemplated that the bearing 6 could be above the generator 5 as well.

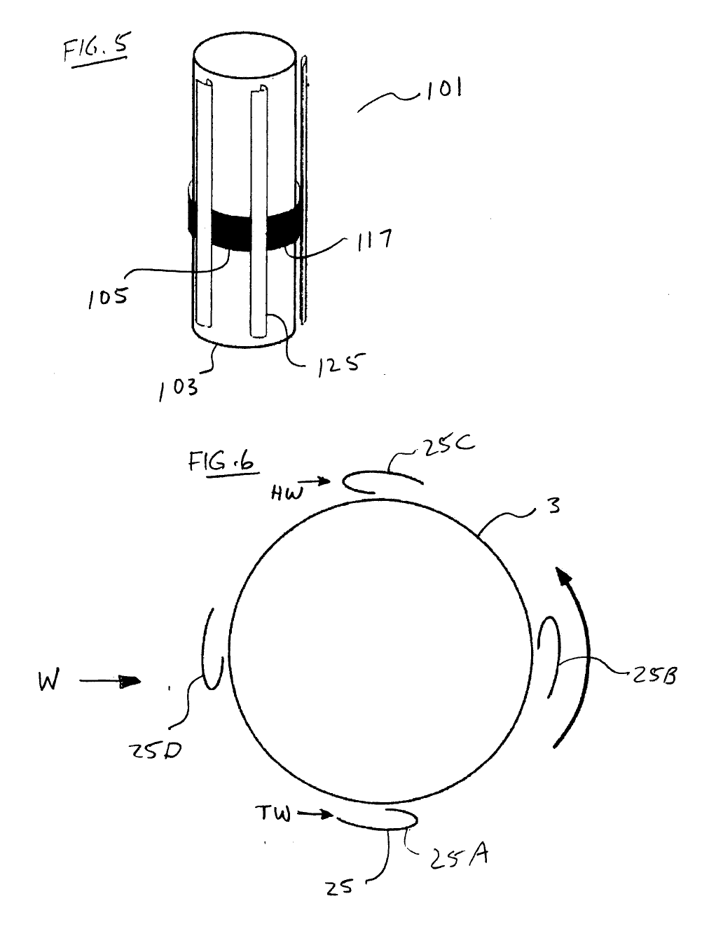

In the apparatus 1 illustrated in FIG. 1, the blades 25 are located in proximity to an exterior surface of the cylindrical object 3 such that wind accelerating along the exterior surface contacts the blades 25. The configuration is schematically illustrated in FIG. 6. The blades 125 in the apparatus 101 of FIG. 5 are similarly configured.

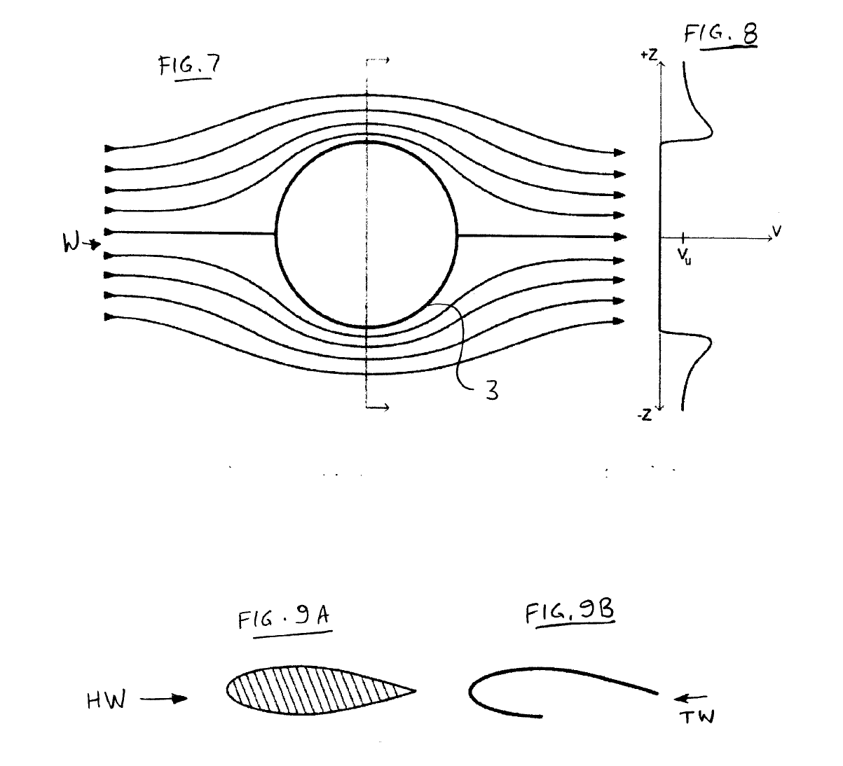

Due to the physics of fluid flow around the cylindrical object 3, the wind speed increase at the cylinder sides parallel to wind direction. Because the rate of mass transfer of air must be the same upstream and downstream from the cylindrical object 3, the air moves faster along the sides of the cylindrical object 3. The increase in wind speed can be as high as twice the upwind wind speed. This acceleration effect is generally illustrated in FIG. 7, and the increase in wind speed is illustrated in FIG. 8. The blades 25 are configured thus to be close to the outer surface of the cylindrical object 3, where the air is moving faster than the ambient wind speed. Since wind power is exponentially related to wind speed, significant power increases can be obtained when the accelerated wind along the sides of the cylindrical object 3 can be captured by the blades 25.

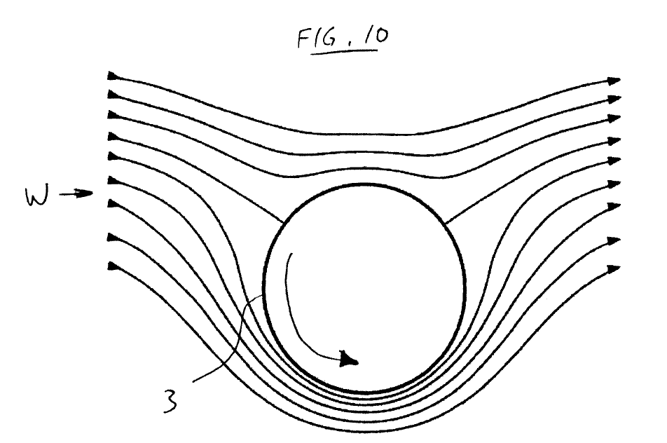

In FIG. 9A, a generic streamlined body is schematically illustrated. It has been designed to provide a small drag coefficient when air passes from left to right in a head wind direction HW. In FIG. 9B the streamline body has been modified to maximize the torque available from the tail wind direction TW from right to left, and illustrated a shape that can be utilized for the blades 25, as illustrated in FIG. 6. The body has been hollowed out to catch the wind in direction TW and provide high drag, while maintaining a minimize counter-torque from the headwind direction HW.

In an initial condition the blades 25 are stationary. Startup can be described regarding FIG. 6. The incoming wind in direction W is captured by the blade 25A in the 6 o'clock position, where the wind is acting as a tail wind TW on the blade 25A. This blade 25A provides the positive torque so that the generator can rotate. The blade 25B at the 3 o'clock position is at a stagnation point (no net torque). The blade 25C in the 12 o'clock position provides a negative toque, but the wind is acting as a head wind HW on this blade 25C, and the negative contribution is relatively small. The blade 25D in the 9 o'clock position is also at a stagnation point and contributes no net torque. The positive torque is provided by the 6 o'clock blade 25A through less than 50% of the total circumference at startup, but as the blade 25A moves toward the stagnant location at 3 o'clock and the positive torque force drops, the blade 25D moves toward 6 o'clock, and begins to exert an increasing positive torque.

Once the blades and generators are rotating, the apparatus 1 will exhibit characteristics of a rotating cylinder and air flow with wind direction W will exhibit the Magnus effect, as schematically illustrated in FIG. 10. The apparatus after startup will exhibit the same phenomena, since the boundary layer near the cylindrical object 3 is being modified in the same way. This effect increases the output power since the blades being pushed have a longer path along the bottom side of the cylindrical object 3 (thus increasing the total positive torque per rotation) while the blades moving upwind have a shorter path (thus reducing the total negative torque per rotation).

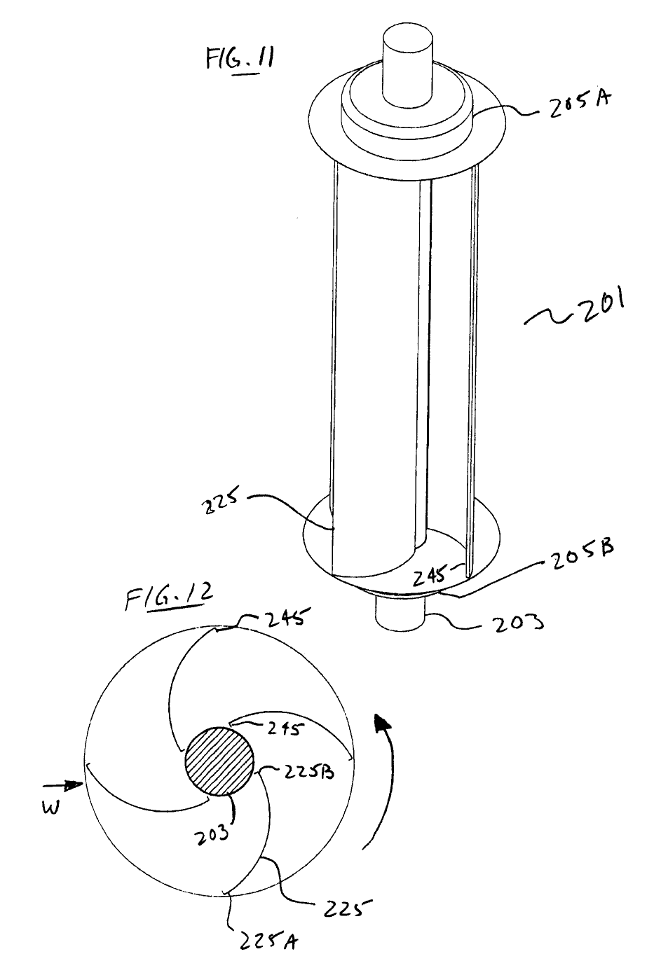

A further alternate embodiment of the apparatus 201 is illustrated schematically in FIGS. 11 and 12. In this apparatus 201 the blades 225 are curved from an inside edge 225A thereof, located nearest the cylindrical object 203, to an outside edge 225B thereof. The inside and outside edges 225A, 225B are bent substantially perpendicular to the blade toward the inside of the curve of the blade 225, to form a flap 245. The flaps 245 increase pressure on the inside of the blade 225 and also increase the blade rigidity. Top and bottom ends of the blades 225 are attached to upper and lower generators 205A, 205B.

It is contemplated that the generator and blades of the present invention do not have to be concentric with the cylindrical object on which they are mounted. The blades could rotate on a collar that is offset from the cylindrical object, but would then require a tail or fin in order to align into the wind. The advantage of this configuration is the downstream blade capturing wind energy would not be compromised, but the upwind movement of the blade would have even less negative torque, since its path is moved away from the cylindrical object where wind speed is not accelerated.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A wind turbine and generator apparatus for mounting on a substantially vertical fixed cylindrical object, the apparatus comprising:
a stationary generator member adapted to be fixed to the cylindrical object such that the stationary generator member encircles the cylindrical object;
a rotating generator member substantially enclosing the stationary generator member, and rotatably supported by the stationary generator member;
a plurality of blades mounted to the rotating generator member such that a wind contacting the blades is operative to rotate the rotating generator member about the stationary generator member to generate electrical energy.

2. The apparatus of claim 1 wherein the stationary generator member defines a central aperture, and wherein the stationary generator member is installed on the cylindrical object by inserting an end of the cylindrical object through the aperture and moving the stationary generator member along the cylindrical object to a desired location.

3. The apparatus of claim 1 comprising:
a plurality of stationary generator components adapted to be assembled around the cylindrical object to form the stationary generator member;
a plurality of rotating generator components adapted to be assembled around the stationary generator member to form the rotating generator member.

4. The apparatus of claim 3 comprising three stationary generator components, each forming one third of the stationary generator member, and wherein each stationary generator component generates one phase of a three phase electrical output.

5. The apparatus of claim 4 comprising two rotating generator components, each forming substantially one half of the rotating generator member.

6. The apparatus of claim 1 comprising a plurality of rollers rotatably mounted on the stationary generator member and configured such that the rotating generator member is supported on the rollers for rotation about the stationary generator member.

7. The apparatus of claim 6 comprising a plurality of vertical support rollers rotatably mounted about axes oriented substantially radially with respect to the stationary generator member and wherein a top portion of the rotating generator member rests on the vertical support rollers, and a plurality of lateral support rollers rotatably mounted about axes oriented substantially vertically with respect to the stationary generator member and wherein side portions of the rotating generator member contact the lateral support rollers.

8. The apparatus of claim 1 wherein the blades are configured in an upright orientation and extend at least one of upward and downward from the rotating generator member.

9. The apparatus of claim 1 wherein the blades are configured in an upright orientation and comprising:
a bearing comprising a stationary bearing member adapted to be fixed to the cylindrical object above or below the stationary generator member and a rotating bearing member rotatably supported on the stationary bearing member; and
wherein the blades are attached to the rotating generator member and the rotating bearing member.

10. The apparatus of claim 8 wherein the blades are located in proximity to an exterior surface of the cylindrical object such that wind accelerating along the exterior surface contacts the blades.

11. The apparatus of claim 8 wherein at least one blade is curved from an inside edge thereof, located nearest the cylindrical object, to an outside edge thereof, and wherein the inside and outside edges are bent substantially perpendicular to the at least one blade toward the inside of the curve of the at least one blade.

12. The apparatus of claim 1 wherein the cylindrical object comprises one of a chimney, a pole, and a rigid pipe.

13. The apparatus of claim 12 wherein the cylindrical object is an electrical utility pole supporting at least one electrical conductor, and comprising a circuit adapted to be connected to the stationary generator member and the at least one electrical conductor and configured to transform the electrical energy generated as required and conduct the transformed electrical energy into the at least one electrical conductor.

14. An apparatus for generating electricity from wind, the apparatus comprising:
a substantially vertical electrical utility pole supporting at least one electrical conductor;
a stationary generator member encircling the utility pole and fixed to the utility pole;
a rotating generator member substantially enclosing the stationary generator member, and rotatably supported by the stationary generator member;
a plurality of blades mounted to the rotating generator member such that a wind contacting the blades is operative to rotate the rotating generator member about the stationary generator member to generate electrical energy; and
a circuit connected to the stationary generator member and the at least one electrical conductor and is configured to transform the electrical energy generated as required and to conduct the transformed electrical energy into the at least one electrical conductor.

15. The apparatus of claim 14 wherein the stationary generator member defines a central aperture, and wherein the stationary generator member is installed on the electrical utility pole by inserting an end of the electrical utility pole through the aperture and moving the stationary generator member along the electrical utility pole to a desired location.

16. The apparatus of claim 14 comprising:
a plurality of stationary generator components adapted to be assembled around the electrical utility pole to form the stationary generator member;
a plurality of rotating generator components adapted to be assembled around the stationary generator member to form the rotating generator member.

17. The apparatus of claim 16 comprising three stationary generator components, each forming one third of the stationary generator member, and wherein each stationary generator component generates one phase of a three phase electrical output, and two rotating generator components, each forming substantially one half of the rotating generator member.

18. The apparatus of claim 16 comprising a plurality of rollers rotatably mounted on the stationary generator member and configured such that the rotating generator member is supported on the rollers for rotation about the stationary generator member.

19. The apparatus of claim 18 comprising a plurality of vertical support rollers rotatably mounted about axes oriented substantially radially with respect to the stationary generator member and wherein a top portion of the rotating generator member rests on the vertical support rollers, and a plurality of lateral support rollers rotatably mounted about axes oriented substantially vertically with respect to the stationary generator member and wherein side portions of the rotating generator member bear contact the lateral support rollers.

20. The apparatus of claim 14 wherein the blades are configured in an upright orientation and extend at least one of upward and downward from the rotating generator member.

21. The apparatus of claim 20 wherein the blades are located in proximity to an exterior surface of the electrical utility pole such that wind accelerating along the exterior surface contacts the blades.

22. The apparatus of claim 14 wherein the blades are configured in an upright orientation and comprising:
a bearing comprising a stationary bearing member adapted to be fixed to the electrical utility pole above or below the stationary generator member and a rotating bearing
member rotatably supported on the stationary bearing member; and
wherein the blades are attached to the rotating generator member and the rotating bearing member.

23. The apparatus of claim 20 wherein at least one blade is curved from an inside edge thereof, located nearest the electrical utility pole, to an outside edge thereof, and wherein the inside and outside edges are bent substantially perpendicular to the at least one blade toward the inside of the curve of the at least one blade.
